(19) United States
(12) Patent Application Publication
(10) Pub. No.: US 2011/0127453 A1
(43) Pub. Date: Jun. 2, 2011

(54) BURGLAR PROOF LIQUID SPRAYING DEVICE

(76) Inventor: TIAN-CHUAN LIU, Hsinchu County (TW)

(21) Appl. No.: 12/626,946

(22) Filed: Nov. 30, 2009

(51) Int. Cl. F16K 31/02

(52) U.S. Cl. 251/129.03

(57) ABSTRACT

A burglar proof liquid spraying device comprises a circuit board; a liquid bottle storing spraying liquid and high pressure gas; the spraying liquid will cause a person not to act in certain time period as the liquid is sprayed on a body of a person; the liquid bottle 10 has an opening and a metal tube is extended out from the metal tube; an electromotive valve connected to the liquid bottle for controlling spraying of the spraying liquid in the liquid bottle; a liquid guiding tube having a first end connected to the electromotive valve and a second end connected to a spraying head; an AC to DC convertor for converting high voltage electric power into low voltage electric power so as to provide DC current to the electromotive valve for actuating the electromotive valve; and at least one actuating button is connected to a joint on the circuit board for actuating the electromotive valve 14 to operate.

### FIELD OF THE INVENTION

The present invention relates to a burglar proof liquid spraying device, wherein a special liquid can be sprayed to a body of a burglar so that the burglar can be caught quickly and easily. Furthermore, the burglar proof liquid spraying device can be hidden without discovering by burglars.

### BACKGROUND OF THE INVENTION

Currently, robberies occur very frequently, especially in banks, supermarkets, convenience stores, etc. Generally, robberies occur in very short time period. The robs escape from the scenes quickly. It is difficult to catch the robs at the occurring time. However, when the robs escapes from the scene, it will increase the difficulty to catch them.

Thus there is an eager demand for a novel device which can resolve the above mentioned problem.

### SUMMARY OF THE INVENTION

Accordingly, the object of the present invention is to provide a burglar proof liquid spraying device, wherein a special liquid can be sprayed to a body of a burglar so that the burglar can be caught quickly and easily. Furthermore, the burglar proof liquid spraying device can be hidden without discovering by burglars.

A burglar proof liquid spraying device comprises a circuit board; a liquid bottle storing spraying liquid and high pressure gas; the spraying liquid will cause a person not to act in certain time period as the liquid is sprayed on a body of a person; the liquid bottle 10 has an opening and a metal tube is extended out from the metal tube; an electromotive valve connected to the liquid bottle for controlling spraying of the spraying liquid in the liquid bottle; a liquid guiding tube having a first end connected to the electromotive valve and a second end connected to a spraying head; an AC to DC convertor for converting high voltage electric power into low voltage electric power so as to provide DC current to the electromotive valve for actuating the electromotive valve; and at least one actuating button is connected to a joint on the circuit board for actuating the electromotive valve 14 to operate.

The various objects and advantages of the present invention will be more readily understood from the following detailed description when read in conjunction with the appended drawing.

### BRIEF DESCRIPTION OF THE DRAWINGS

FIG. 1 is an element block of the present invention.

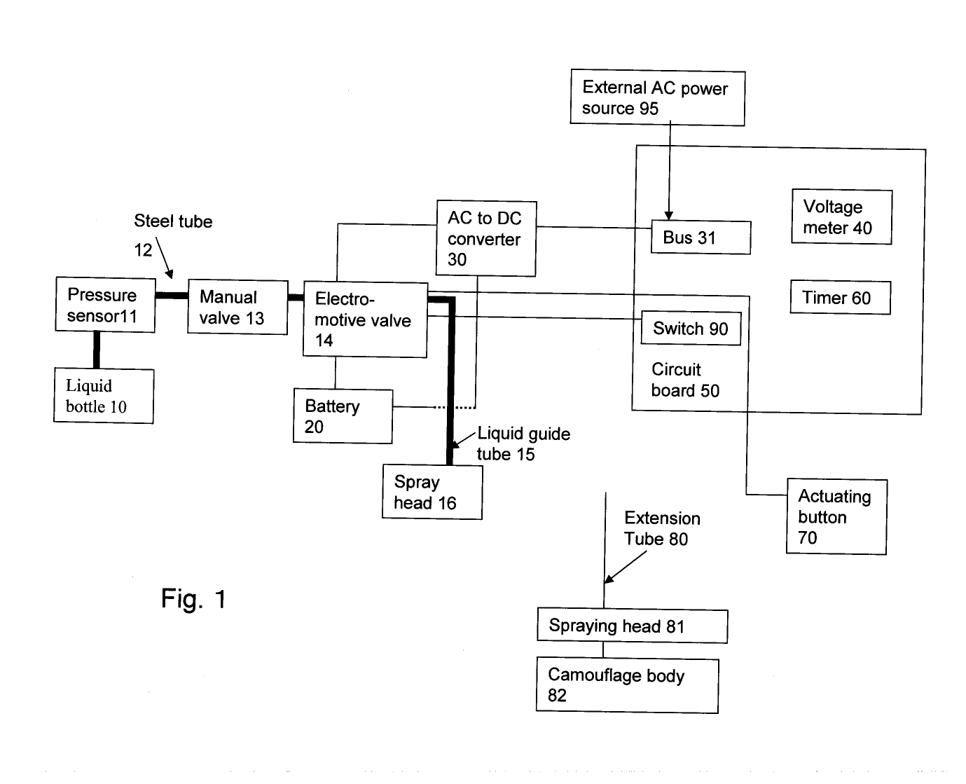

FIG. 2 is an exploded view of the present invention.

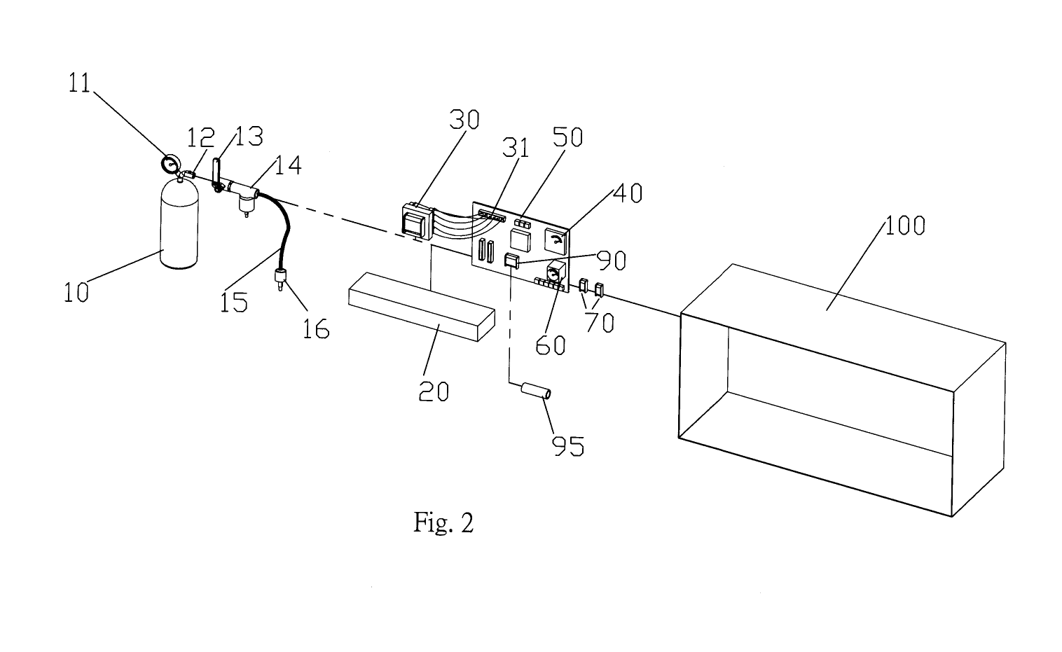

FIG. 3 is an assembled view of the present invention.

FIG. 4 is an assembled view about the extension tube and the camouflage body of the present invention.

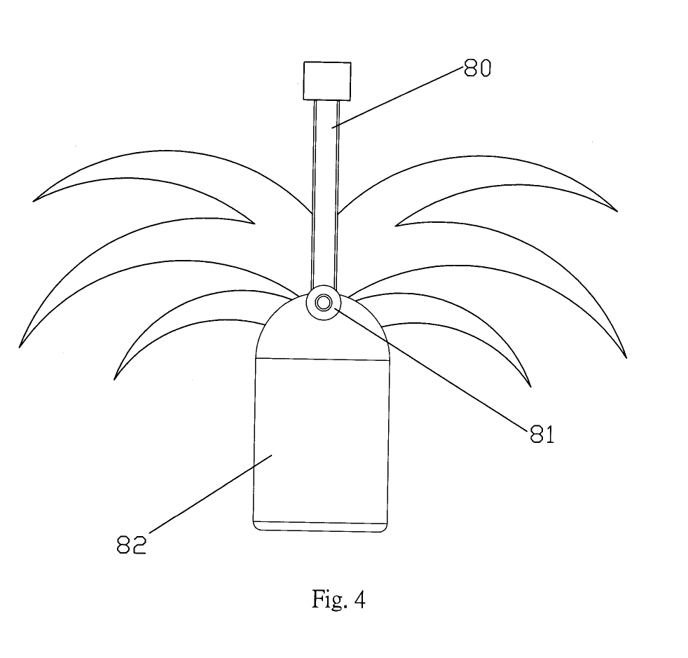

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

A circuit board 50 has related circuit elements about the present invention.

A battery 20 serves for supplying power to the element of the present invention. One end of the battery 20 is electrically connected to the circuit board 50 for supplying power to other elements through the circuit board 50. Therefore, the present invention can operate even no external power.

A liquid bottle 10 stores spraying liquid and high pressure gas (such as nitrogen gas). The spraying liquid will cause one not to act in certain time period as the liquid is sprayed on the body of a person. The liquid bottle 10 has an opening and a metal tube 12 is extended out from the metal tube 12. Generally, the pressure within the liquid bottle 10 is greater than 10 kgw for providing sufficient pressure to drive the liquid out of the liquid bottle 10 as the opening of the liquid bottle 10 is opened.

A manual operating valve 13 is located at an outer end of metal tube 12.

An electromotive valve 14 is connected to an outer end of the manual operating valve 13 for controlling the spraying of the spraying liquid. The manual operating valve 13 can close the flowing path of the liquid in the liquid bottle 10 for testing the function of the electromotive valve 14.

A liquid guiding tube 15 has a first end connected to the electromotive valve 14 and a second end connected to a spraying head 16 which is detachable.

An AC to DC convertor 30 serves for converting high voltage (such 120V) electric power into low voltage (such as 24V) electric power so as to provide DC current to the electromotive valve 14 for actuating the electromotive valve 14. Furthermore, the DC power can provide to the battery 20 for charging to the battery 20.

A pressure sensor 40 servers for measuring the DC voltage at an output end of the AC to DC convertor 30.

A timer 60 serves for setting the operation time period of the electromotive valve 14, for example 6 seconds. In the present invention, the timer 60 is installed on the circuit board 50.

At least one actuating button 70 is connected to a joint on the circuit board 50 for actuating the electromotive valve 14 to operate. Preferably, at least two actuating buttons 70 are installed so that the user can actuate the electromotive valve 14 at different locations.

An extension tube 80 has one end connected to the second end of the liquid guiding tube 15 and a second end connected to another spraying head 81 so that the liquid in the liquid bottle 10 can be guided to a far place through the extension tube 80.

A camouflage body 82 serves to install a second end of the extension tube 80 and a spraying head 81 thereof so as to hid the extension tube 80 and the spraying head 81 not to expose out and thus not to be discovered. As required, the liquid in the liquid bottle 10 can be sprayed out from the spraying head 81.

A casing 100 serves for installing the liquid bottle 10, the electromotive valve 14, the circuit board 50, the liquid guiding tube 15, etc. A lower side of the casing has an opening for exposing the spraying head 16. A lateral side of the casing 100 has openings for protruding the actuating buttons 70 so that the actuating button 70 can be extended to a farther place. Thus the user can actuate the electromotive valve 14 from the farther place.

A switch 90 serves to open or close the electromotive valve 14.

Further, an external AC power source 95 is used to transfer the AC power to the AC to DC convertor 30 through a bus 31.

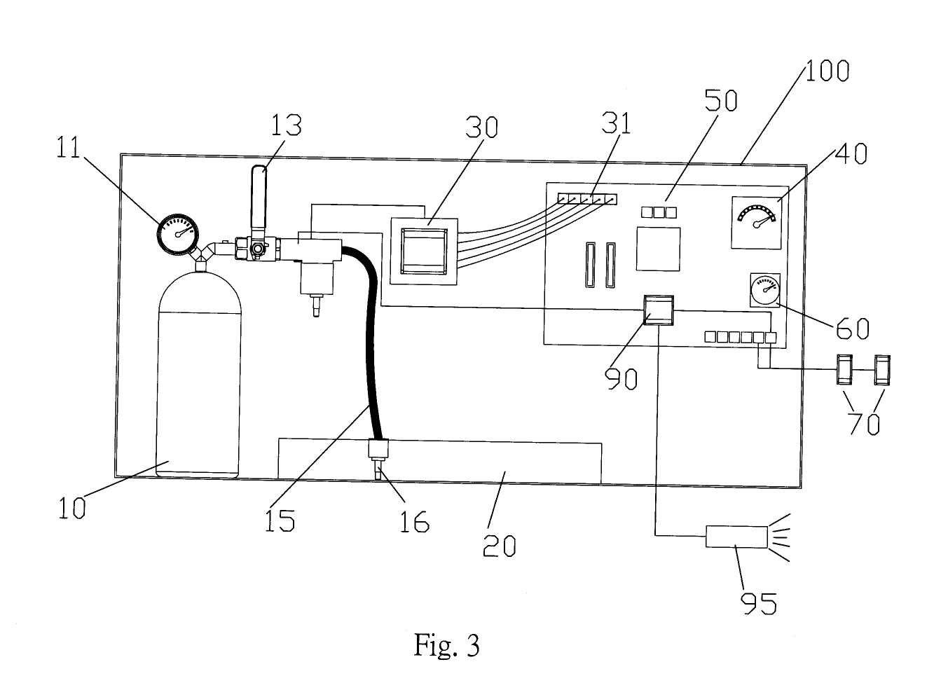

FIG. 3 shows the installation of the present invention. The liquid bottle 10 is installed at a right lower side of the casing 100. The liquid bottle 10 has an opening. The metal tube 12 is extended from the opening of the liquid bottle 10. A manual operating valve 13 is connected to an outer side of the metal tube 12. The electromotive valve 14 is connected to an outer end of the manual operating valve 13. A first end of the liquid guiding tube 15 is connected to the electromotive valve 14. A second end of the liquid guiding tube 15 is connected to the spraying head 16. The circuit board 50 is installed within the casing. The element circuit elements of the present invention are installed on the circuit board 50. The pressure sensor 11 and the timer 60 are installed upon the circuit board 50. The AC to DC convertor 30 has an AC input end and a DC output end. The DC output end is connected to the electromotive valve 14 and the battery 20.

The present invention can be used with an infrared detector or a RF detector. If abnormal human motion is detected, the detector will actuate the electromotive valve 14 to spray the liquid from the liquid bottle 10 so as to have the effect of burglar proof.

The use of the present invention will be described. The casing 100 can be installed at a higher place, such as an upper side of a door. The actuating button 70 is installed to a place easily accessible by the user. When camouflage body is placed at a place which is a pass way of a burglar.

In the present invention, preferably, the liquid in the liquid bottle is a solution containing water, cayenne pepper, mustard, natural nano-bacteriostat, emulsion, and potassium sorbate. The solution will make the burglar ejected by the solution feeling very uneasy and can not act within a time period. Thus other people can capture the burglar easily and quickly, while the solution do not harm the human body.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A burglar proof liquid spraying device, comprising:
a circuit board;
a liquid bottle storing spraying liquid and high pressure gas; the spraying liquid will cause a person not to act in certain time period as the liquid is sprayed on a body of a person; the liquid bottle 10 has an opening and a metal tube is extended out from the metal tube;
an electromotive valve connected to the liquid bottle for controlling spraying of the spraying liquid in the liquid bottle;
a liquid guiding tube having a first end connected to the electromotive valve and a second end connected to a spraying head;
an AC to DC convertor for converting high voltage electric power into low voltage electric power so as to provide DC current to the electromotive valve for actuating the electromotive valve; and
at least one actuating button is connected to a joint on the circuit board for actuating the electromotive valve 14 to operate.

2. The burglar proof liquid spraying device as claimed in claim 1, wherein a switch serves to open or close the electromotive valve.

3. The burglar proof liquid spraying device as claimed in claim 1, wherein at least two actuating buttons are installed so that the user can actuate the electromotive valve at different locations.

4. The burglar proof liquid spraying device as claimed in claim 1, wherein a pressure sensor servers for measuring the DC voltage at an output end of the AC to DC convertor.

5. The burglar proof liquid spraying device as claimed in claim 1, wherein a timer serves for setting the operation time period of the electromotive valve.

6. The burglar proof liquid spraying device as claimed in claim 1, wherein a manual operating valve is located at an outer end of a metal tube connected to an opening of the liquid bottle; and the electromotive valve is connected to the manual operating valve.

7. The burglar proof liquid spraying device as claimed in claim 1, wherein a pressure sensor is installed at an opening of the liquid bottle for measuring a pressure of an interior of the liquid bottle.

8. The burglar proof liquid spraying device as claimed in claim 1, wherein a battery serves for supplying power; one end of the battery is electrically connected to the circuit board for supplying power to other elements through the circuit board.

9. The burglar proof liquid spraying device as claimed in claim 8, wherein the DC current is also supplied to the battery for charging electric power to the battery.

10. The burglar proof liquid spraying device as claimed in claim 1, further comprising:
an extension tube having one end connected to the second end of the liquid guiding tube and a second end connected to another spraying head so that the liquid in the liquid bottle can be guided to a far place through the extension tube; and
a camouflage body installing with a second end of the extension tube and a spraying head thereof so as to hid the extension tube and the spraying head not to expose out and thus not to be discovered.

11. The burglar proof liquid spraying device as claimed in claim 1, further comprising:
a casing for installing the liquid bottle, the electromotive valve, the circuit board, the liquid guiding tube; a lower side of the casing has an opening for exposing the spraying head.

12. The burglar proof liquid spraying device as claimed in claim 1, wherein the liquid in the liquid bottle is a solution containing water, cayenne pepper, mustard, natural nano-bacteriostat, emulsion, and potassium sorbate.

13. The burglar proof liquid spraying device as claimed in claim 1, further comprising an infrared detector or a RF detector.
